(19) United States
(12) Patent Application Publication
(10) Pub. No.: US 2008/0123633 A1
(43) Pub. Date: May 29, 2008

(54) SERVER APPARATUS

(75) Inventors: Koji Shima, Sagamihara-shi (JP); Shigeru Fukazawa, Hachioji-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/939,266

(22) Filed: Nov. 13, 2007

(30) Foreign Application Priority Data
Nov. 28, 2006 (JP) 2006-320373

(51) Int. Cl. H04L 12/66

(52) U.S. Cl. 370/352

(57) ABSTRACT

According to one embodiment, a server apparatus includes a memory which stores a participation registration table in which each telephone ID of a first telephone terminal, a second telephone terminal and a third telephone terminal among the plurality of telephone terminals is associated with participation information showing the fact of participation in a conference by a paging function of supplying voice signals to the first, second and third telephone terminals, a receiver which receives a information event showing the paging function, and a controller which refers to the participation registration table based on the telephone IDs included in the information event, and makes communication connections among the data terminals associated with the telephone IDs of the first, the second and the third telephone terminals, respectively, based on a reference result of the participation registration table.

### CROSS-REFERENCE TO RELATED APPLICATIONS

This application is based upon and claims the benefit of priority from Japanese Patent Application No. 2006-320373, filed Nov. 28, 2006, the entire contents of which are incorporated herein by reference.

### BACKGROUND

1. Field

One embodiment of the present invention relates to an improvement on a server apparatus in a visual communication system configured to connect the server apparatus, for example, to a telephone exchange apparatus through a communication channel and to handle a video signal, computer data, etc., in addition to a voice signal.

2. Description of the Related Art

Local area networks (LANs) have been used in offices and business establishments. The LAN encompasses, for example, telephones in a telephone exchange apparatus such as a private branch exchange (PBX) and a key telephone, and exchange-connects among extension terminals and an external communication network such as a public network and among extension terminals to make telephone calls.

Recently, a system, which connects a server with data terminals such as video telephone terminals and personal computers connected thereto to a telephone exchange apparatus via a transmission channel and associates a voice communication system using the telephone exchange apparatus with a data communication system using the server, has been proposed.

Meanwhile, the aforementioned parallel type of telephone exchange apparatus and the server establishes a video conference etc., sometimes, and in this case, using a multi-point control unit (MCU) is a possible approach. However, in the case of the use of the MCU, establishing the video conference among a small number of persons with high frequency is apt to pose a shortage of conference resources of the MCU. Also in the case of a one-way video conference of a one-to-many type such that, for example, an executive officer of a corporate gives instructions to a plurality of corporate stuffs, a conference organizer has to call many users, who are desired to be participants in the video conference by the organizer, one by one by the use of the telephone terminals, and it becomes a hard task for the organizer. Therefore, to hold the one-way video conference of the one-to-many type, a system, utilizing a paging function which has been already provided for the telephone exchange apparatus without having to perform complicated operations through the conference function of the telephone exchange apparatus, has been taken into consideration (for example, Jpn. Pat. Appln. KOKAI Publication No. 4-304796).

However, the aforementioned system is not applicable to a visual communication system (hereinafter referred to as a VCS) in which data communication connections among the data terminals are related to call statuses of the telephone terminals.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a preferred schematic configuration view illustrating a VCS regarding the first embodiment of the invention;

FIG. 2 is a preferred block diagram illustrating a functional configuration of a VCS server illustrated in FIG. 1;

FIG. 3 is a preferred view illustrating an example of storage contents of a connection information management table illustrated in FIG. 2;

FIG. 4 is a preferred view illustrating an example of storage contents of an extension terminal-visual communication associating table illustrated in FIG. 2;

FIG. 5 is a preferred view illustrating an example of storage contents of a session information management table illustrated in FIG. 2;

FIG. 6 is a preferred view illustrating an example of storage contents of a participation registration information table illustrated in FIG. 2;

FIG. 7 is a preferred schematic sequence view illustrating origination and termination operations of information among extension terminals, a main apparatus, a VCS server, a broadcast video server, and data terminals in applying session control related with a one-way video conference in the first embodiment of the invention;

FIG. 8 is a preferred flowchart illustrating a control procedure of the main apparatus in being conference-connected by means of a paging function in the first embodiment of the invention;

FIG. 9 is a preferred flowchart illustrating a control procedure of the VCS server in being conference-connected by means of the paging function in the first embodiment of the invention; and

FIG. 10 is a preferred flowchart illustrating a control procedure of a VCS server when users of data terminals participate in a one-way video conference as the second embodiment of the invention.

### DETAILED DESCRIPTION

Various embodiments according to the invention will be described hereinafter with reference to the accompanying drawings, in general, according to one embodiment of the invention, a server apparatus which receives call information event including telephone IDs specifying a plurality of telephone terminals to be brought into call connections and relates communication connections at a plurality of data terminals associated with the plurality of telephone IDs of the plurality of telephone terminals, respectively, to the call connections, comprising: a memory which stores a participation registration table in which each telephone ID of a first telephone terminal, a second telephone terminal and a third telephone terminal among the plurality of telephone terminals is associated with participation information showing the fact of participation in a conference by a paging function of supplying voice signals to the first, second and third telephone terminals, to perform the paging function of supplying voice signal in one direction from the first telephone terminal to the second and the third telephone terminals; a receiver which receives a information event showing the paging function; and a controller which refers to the participation registration table based on the telephone IDs included in the information event when the receiver receives the information event, and makes communication connections among the data terminals associated with the telephone IDs of the first, the second and the third telephone terminals, respectively, based on a reference result of the participation registration table.

### First Embodiment

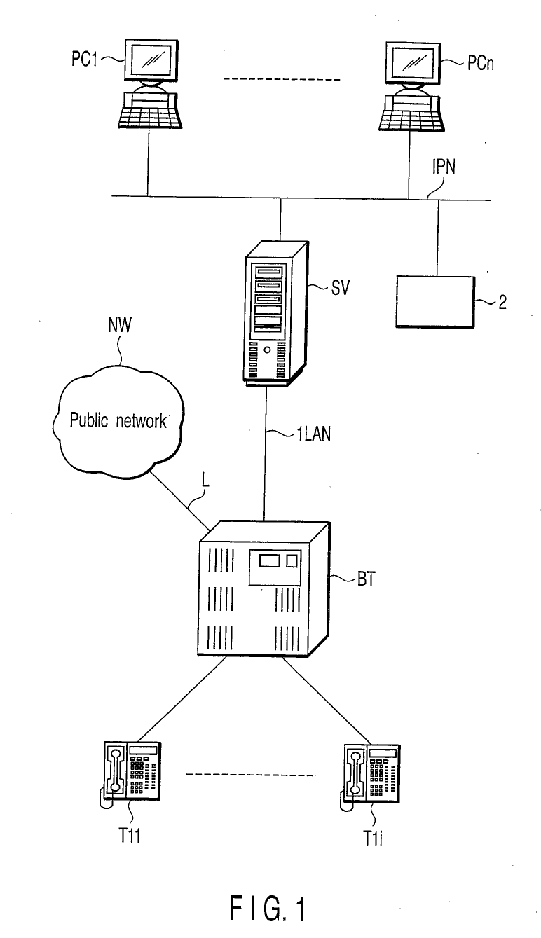

FIG. 1 shows a schematic configuration view sowing a VCS regarding the first embodiment of the invention.

The VCS includes, as depicted in FIG. 1, a main apparatus BT and a VCS server SV, and connects between the main apparatus BT and the VCS server SV via a local area network (LAN) 1.

The main apparatus BT encompasses extension terminals T11-T1i through via extensions. The main apparatus BT is connected to a public network NW via an office line L. The main apparatus BT implements exchange processing among the extension terminals T11-T1i, or among the extension terminals T11-T1i and the public network NW.

The VCS server SV encompasses a plurality of data terminals PC1-PCn and a broadcast video server 2 as a broadcast processing unit via an Internet Protocol (IP) network IPN. Each of the data terminals PC1-PCn consists of a general-purpose personal computer, and operates in association with each extension terminal T11-T1i, respectively. The broadcast video server 2 performs session processing among the data terminals PC1-PCn on the basis of conference control information from the VCS server SV, and distributes a conference video signal of a data terminal PC1 to be, for example, a conference organizer to the data terminals PC2-PCn by broadcast.

The VCS server SV implements an additional function to the main apparatus BT, handles media information, for example, of a video etc.

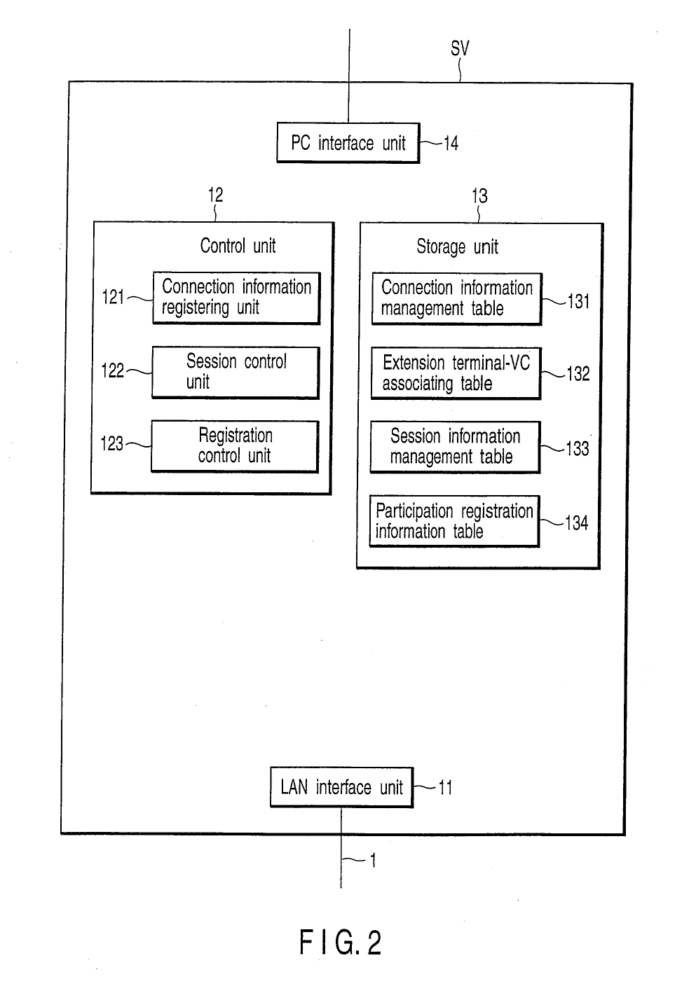

FIG. 2 depicts a block diagram illustrating a functional configuration of the aforementioned VCS server SV.

The VCS server SV includes a LAN interface unit 11, a control unit 12, a storage unit 13 and a PC interface unit 14. Among of them, the LAN interface unit 11 conducts interface processing to and from the LAN 1.

The PC interface unit 14 conducts interface processing among the data terminals PC1-PCn and the video server 2.

The storage unit 13 stores routing information etc., necessary for connection control to be performed by the control unit 12. Further, the storage unit 13 is provided with a connection information management table 131 (hereinafter referred to as a table 131), an extension terminal-VC associating table 132 (hereinafter referred to as a table 132), a session information management table 133 (hereinafter referred to as a table 133) and a participation registration information table 134 (hereinafter referred to as a table 134).

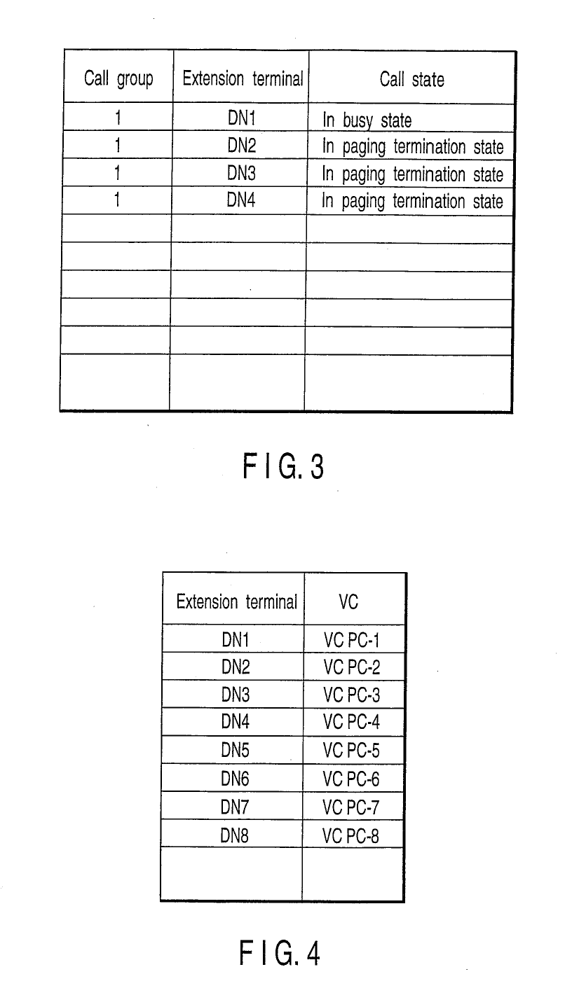

As shown in FIG. 3, data showing correspondence relations of calling groups, respective telephone numbers (telephone IDs) of the extension terminals T11-T1i, and state information showing calling states is stored in the table 131. Symbols DN1-DN4 indicate telephone IDs of the extension terminals T11-T14, respectively. Here, to simplify the description, the extension terminals T11-T1i are expressed on behalf of all the extension terminals.

As illustrated in FIG. 4, data showing the correspondence relations among the extension terminals T11-T1i and the data terminals (referred to as VCs) VC PC1-VC PCn is stored in the table 132. VC PC-1 to VC PC-8 in FIG. 3 indicate each user ID of the data terminals PC1-PC8, respectively.

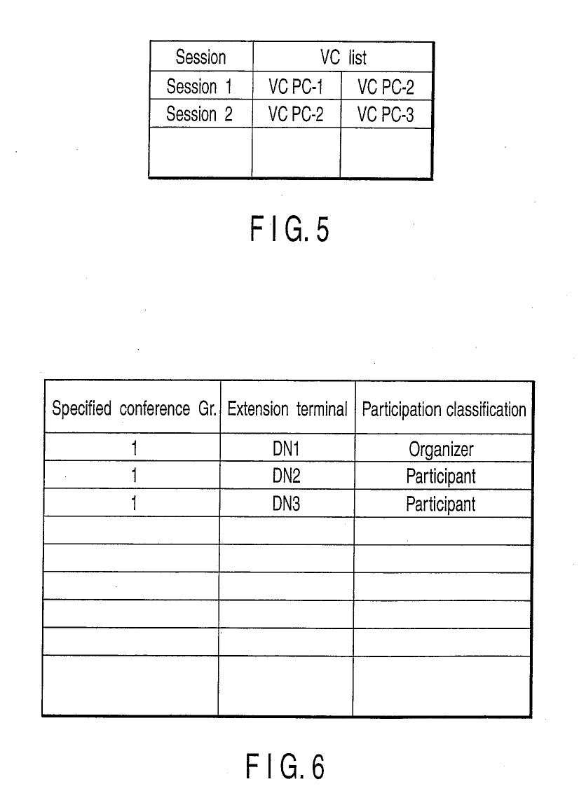

As shown in FIG. 5, information showing session states among the data terminals PC1-PCn is stored in the table 133.

As depicted in FIG. 6, data showing correspondence relations among specified conference groups, telephone numbers of the extension terminals T11-T1i and participation classifications telling an organizer and participants of the one-way conference is stored in the table 134.

The control unit 12 has a connection information registering unit 121 (hereinafter referred to as a registering unit 121), a session control unit 122 and a registration control unit 123 as new functions regarding the invention in addition to a control function regarding state management of the data terminals PC1-PCn and regarding cooperation operations among the data terminals PC1-PCn and extension terminals T11-T1i.

The registering unit 121 determines that, for example, an extension terminal T15 and an extension terminal T16 are brought into a busy state by analyzing a call information event noticed from the main apparatus BT, and registers a correspondence relation between “DN5” and “in busy state”, and a correspondence relation between “DN6” and “in busy state”. By analyzing the call information event, when, for example, the extension terminals T11-T14 are connected in a one-way conference manner by paging functions, the registering unit 121 registers a correspondence relation between “DN1” and “in paging termination”, a correspondence relation between “DN2” and “in paging termination”, a correspondence relation between “DN3” and “in paging termination”, and a correspondence relation between “DN4” and “in paging termination”.

The session control unit 122 reads out that the extension terminal T15 is associated with the data terminal PC5 (VC PC-5) and the extension terminal T16 is associated with the data terminal PC6 (VC PC-5) from the table 132, and retrieves the session state of the data terminals PC5 and PC6 from the table 133 based on the updated state information. For example, when starting a speech from now, since the data terminals PC5 and PC6 have not being in speech states yet, the session control unit 122 controls so as to start the session between the data terminals PC5 and PC6. When the session between the data terminals PC5 and PC6 is established, the control unit 122 updates the storage contents of the table 133.

When receiving the call information event meaning a paging function, the session control unit 122 determines whether or not the telephone ID included in the information event has registered in the table 134, and retrieves the session states of the data terminals PC1-PC4 to be associated with the already registered telephone numbers from the table 133 by referring to the table 132 based on the determination result. If a one-way video conference is started from now, the session control unit 122 includes the conference control information including the user IDs of the data terminals PC1-PC4 to be session targets into a session control instruction to transmit it to the broadcast video server 2.

When a registration request for the one-way video conference from the extension terminal T15 to be unregistered in the table 134, the registration control unit 123 associates among the conference group in which the user of the extension terminal T15 desires to be a participant, the telephone number thereof, and the participation classification to register them in the table 134.

The following will describe operations of the VCS configured as given above.

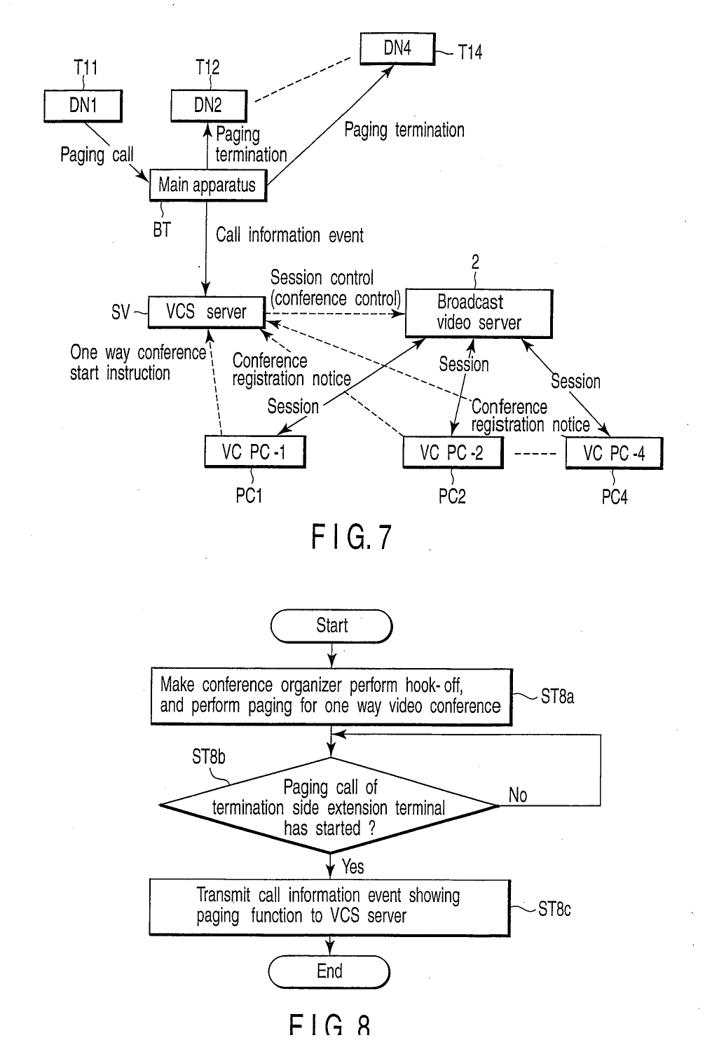

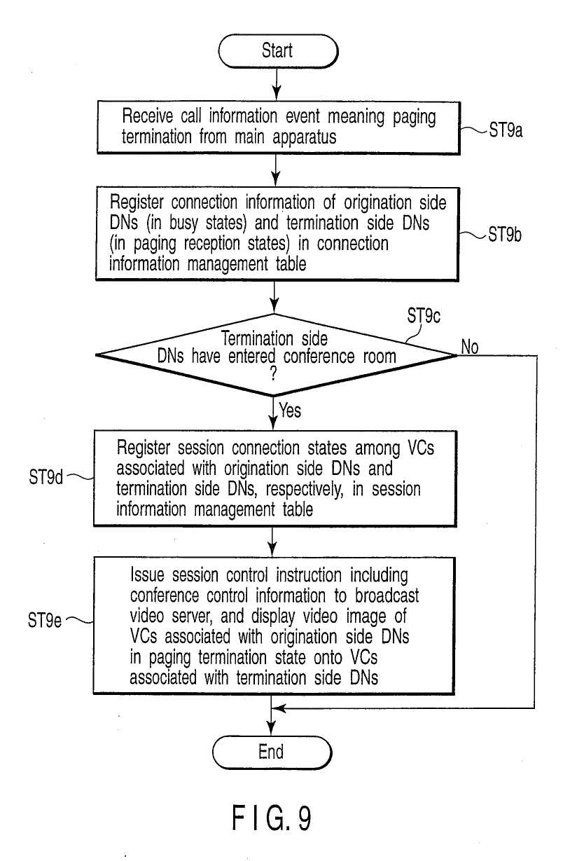

FIG. 7 shows a sequence view illustrating operations in the case in which the extension terminals T11-T14 establish the sessions of each data terminal PC1-PC4 which have been conference-connected by the paging functions. FIG. 8 shows a flowchart illustrating a control processing procedure of the main apparatus BT at that time, and FIG. 9 shows a flowchart illustrating a control processing procedure of the VCS server SV.

Prior to the implementation of the one-way video conference, the users of the data terminals PC1-PC4 that are conference members register their participation in the one-way video conference in the table 134 of the VCS server SV.

When an origination-side extension terminal T11 is hooked off to perform a paging operation to implement the one-way video conference, the main apparatus BT sifts from block ST8a to block ST8b, and there it determines whether or not the conference organizer has started the paging of the termination-side extension terminals T12-T14. If the organizer has started the paging (Yes), the main apparatus BT transmits the call information event meaning the paging termination including connected person information (origination-side DN, termination-side DN) to the VCS server SV (block ST8c).

The VCS server SV shifts from block ST9a to block ST9b to register the connected person information (origination-side DN (in busy state), termination-side DN (in paging termination state) included in the received call information event in the table 131.

After this, the VCS server SV refers to the table 134 to determine whether or not the connected person information (termination-side DN) included in the received call information event has registered (has entered a conference room) (block ST9c). If the termination-side DN has not entered the conference room, the main apparatus BT terminates the processing, and otherwise stated, the VCS server registers the session connection states among the data terminals PC1-PC4 associated with the origination-side DN1 and the termination-side DN2-DN4, respectively, in the table 133 (block ST9d).

Next, the VCS server SV issues a session control instruction including conference control information to the broadcast video server 2, and distributes a video image of the data terminal PC1 associated with the origination-side DN to the data terminals PC2-PC4 associated with the termination-side DN in a paging termination state to display a video image (block ST9e)

As mentioned above, in the first embodiment of the invention, in the VCS server SV, the table 134 in which the group names, the respective extension telephone numbers (DN1-DN4) of the extension terminals T11-T14 and the participation classifications telling the organizer and the participants are associated with one another is provided for the storage unit 13. When receiving the call information meaning the paging function from the main apparatus BT, the VCS server SV refers to the information table 134 based on the extension telephone numbers included in the call information event to make the broadcast video server 2 execute the session control among data terminals PC1-PC4 associated with the extension telephone numbers of the extension terminals T11-T14, respectively.

Accordingly, for example, if a one-way video conference of a one-to-many type such that an executive officer of a corporate gives instructions to a plurality of corporate stuffs is held, a one-way video conference of a one-to-many type by means of voice and video may be held to the users of the extension terminals T12-T14 already registered to participate to the one-way video conference at that time only by the operation of the paging calls from the extension terminal T11 to the user who is desired to be an participant in the one-way video conference by the organizer.

In the first embodiment, prior to the execution of the session control associated with the one-way video conference by means of the paging function, the VCS server SV compares between the DNs included in the call information event and the DNs in the table 134, and conducts the session control among data terminals PC1-PC4 associated with the DNs which have been registered on the basis of the comparison result. Therefore, the VCS server SV of the first embodiment may prevent unnecessary session control among the data terminals PC1-PC4 to efficiently hold the one-way video conference depending on the paging function.

In the first embodiment, for performing the session control among the data terminals PC1-PC4 by associating them with the extension terminals T11-T14 which hold the one-way video conference depending on the paging function, the broadcast video server 2 shares to perform the session control among the data terminals PC1-PC4 without relying on the VCS server SV.

Thereby, the session control among the data terminals PC1-PC4 going with conference connections among the extension terminals T11-T14 may be efficiently performed by cooperation the VCS server SV and the broadcast video server 2 with each other.

### Second Embodiment

The second embodiment of the invention will be described the case, as an example, in which a user, who has preliminarily received a participation contact for a one-way video conference including information on the date and time of the conference from a user of an origination-side extension terminal that is a conference organizer (user having data terminal associated with origination-side DN) by means of a (conventional) communication means such as an e-mail, accesses a conference room virtually set and specified on the VCS server SV to enter the room (store participation intension to the conference in the table 134 on the VCS server SV).

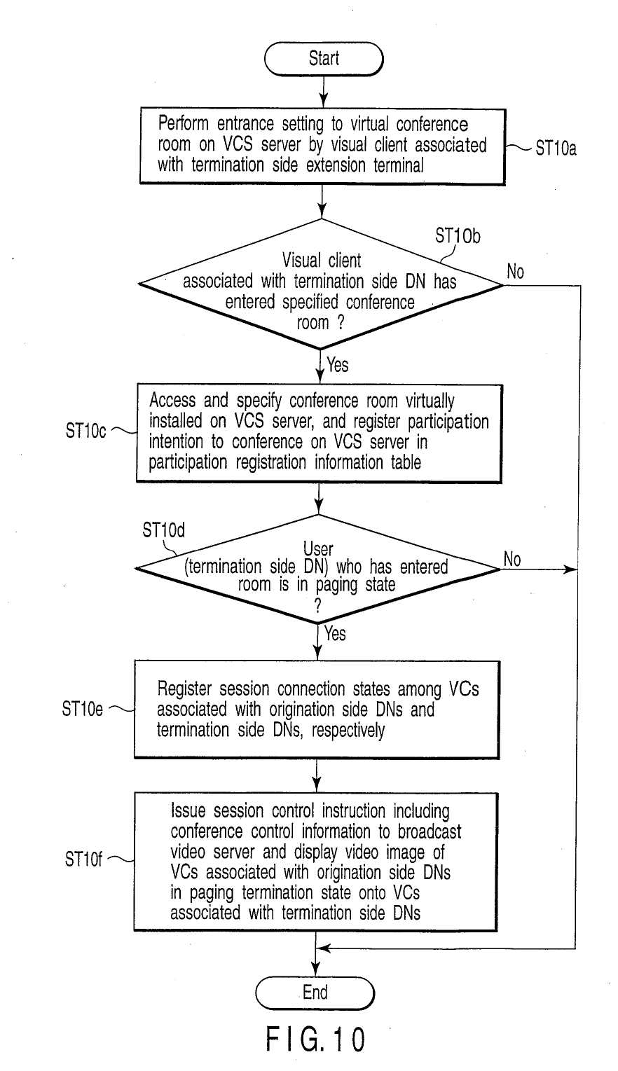

FIG. 10 shows a flowchart showing a control processing procedure of the VCS server SV when a user conducts its registration in the table 134 as the second embodiment of the invention.

When the data terminal PC4 associated with the termination-side extension terminal T14 (DN4) performs setting for entering the virtual conference room on the VCS server SV, the VCS server SV shifts from block ST10a to block ST10b, and there determines whether or not the data terminal PC4 associated with the termination-side DN has already entered the specified conference room.

If the data terminal PC4 associated with the termination-side extension terminal T14 (DN4) has not entered the conference room, the VCS server SV terminates the processing, and otherwise stated, the VCS server SV registers the specified conference group (conference room), the extension telephone number (DN4) of the extension terminal T14 and the participation classification (participant) in the table 134 (block ST10c).

After this, the VCS server SV refers to the table 131 to determine whether or not the user who has entered the room (termination-side DN4) is in a paging termination state (block ST10d). If the user who has entered the room (termination-side DN4) is not in the paging termination state (No), the VCS server SV terminates the processing, and otherwise stated (Yes), the VCS server SV registers the session connection state between the data terminals PC1 and PC4 associated with the origination-side DN1 and the termination-side DN4, respectively, in the table 133 (block ST10e).

Next to this, the VCS server SV issues the session control instruction including the conference control information to the broadcast video server 2, and distributes the video image of the data terminal PC1 associated with the origination-side DN1 to the data terminal PC1 associated with the termination-side DN5 to display a video image (block ST10f).

In the meantime, during holding the one-way video conference among the extension terminals T11-T14, it is assumed that a participation request for the conference arrives at the VCS server SV from the user of the data terminal PC5 which has not been registered in the table 134. The VCS server SV then registers the specified conference group (conference room), the extension telephone number (DN5) of the extension terminal T15 to be associated with the data terminal PC5 and the participation classification (participant) in the table 134, and transmits the call control event necessary to add the extension terminal T15 to the one-way video conference.

After this, the VCS server SV registers the connected person information (origination-side DN-[in busy state], termination-side DN-[in paging termination state]) included in the received call information event in the table 131.

After this, when receiving the call information event from the main apparatus BT, the VCS server SV updates the session connection states among the data terminals PC1-PC4 in the table 133 into the session connection states among the data terminals PC1-PC5, issues the session control instruction including the conference control information to the broadcast video server 2, and distributes the video image of the data terminal PC1 associated with the termination-side DN2-DN5 during paging termination to display the video image.

As mentioned above, in the second embodiment, when the desire for participation in the one-way video conference is made from the user of the extension terminal T14, the VCS server SV associates among the specified conference group (conference room), the DN4 of the extension terminal T14 and the participation classification to register them in the table 134. Thereby, the user of the extension terminal T14 may participate into the one-way video conference with a simple registration operation.

In the second embodiment, if the user of the extension terminal T15 made the participation registration for the conference by means of the data terminal PC5 during session of the one-way video conference, at that time, the VCS server SV may adds the user of the extension terminal T15, who has conducted the participation registration for the one-way video conference, to the one-way video conference of the one-to-many type, thereby a visual communication system (VCS) with high service performance may be provided.

### Other Embodiment

The present invention is not limited to each foregoing embodiment. For instance, in each of the foregoing embodiments, the example which applies the session control among the data terminals when the call information event meaning the paging function is received from the main apparatus has been described. However, there is no need to limit to such example; the conference organizer may specify a plurality of members to whom the organizer asks for the participation as the members in the conference (data terminal associated with termination-side DNs) and may issue a start instruction of a one-way video conference to a VCS server by means of GUIs of the data terminals associated with the origination-side DNs. Thereby, without performing paging operations, the conference organizer automatically makes paging calls from the extension terminal of the organizer to the conference participants, and may ask for the participation of the users who have already entered the conference room in a one-way video conference.

Although each of the aforementioned embodiments has been described in the example in which the main apparatus and the VCS server are separately set, it is understood that the function of the main apparatus may be built into the VCS server.

Further, although each of the given embodiments has been described in the example in which the session control among the data terminals is shared between the VCS server and the broadcast video server, only the VCS server may perform the session control when the number of the data terminals to be brought into the session control is small.

Other than this, also as to a configuration and a type of the VCS server, a type of the telephone exchange apparatus (not limited to main apparatus, but PBX is usable), types of the extension terminals, types of the data terminals, the storage contents of various tables, a session control method among data terminals, etc., can be embodied in various modifications without departing from the concept of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A server apparatus which receives call information event including telephone IDs specifying a plurality of telephone terminals to be brought into call connections and relates communication connections at a plurality of data terminals associated with the plurality of telephone IDs of the plurality of telephone terminals, respectively, to the call connections, comprising:
a memory which stores a participation registration table in which each telephone ID of a first telephone terminal, a second telephone terminal and a third telephone terminal among the plurality of telephone terminals is associated with participation information showing the fact of participation in a conference by a paging function of supplying voice signals to the first, second and third telephone terminals, to perform the paging function of supplying voice signal in one direction from the first telephone terminal to the second and the third telephone terminals;
a receiver which receives a information event showing the paging function; and
a controller which refers to the participation registration table based on the telephone IDs included in the information event when the receiver receives the information event, and makes communication connections among the data terminals associated with the telephone IDs of the first, the second and the third telephone terminals, respectively, based on a reference result of the participation registration table.

2. The server apparatus according to claim 1, further comprising:
an updating unit which updates the participation registration table to associate a telephone ID of a fourth telephone terminal not registered in the participation registration information table with the participation information, when a registration request is made from the fourth telephone terminal to the participation registration table.

3. The server apparatus according to claim 1, wherein
the controller includes a determining unit to determine whether or not the telephone IDs of the first, the second and the third telephone terminals are registered in the participation registration table to perform the paging function, when the receiver receives the information event, and
a unit to make communication connections among the data terminals associated with the registered telephone IDs based on a determination result of the determining unit.

4. The server apparatus according to claim 1, further comprising:
an interface which connects a telephone exchange apparatus to perform exchange processing among the plurality of telephone terminals, wherein
the receiver receives the information event to be noticed from the telephone exchange apparatus via the interface,
the controller refers to the participation table based on the information event, and makes communication connections among the data terminals associated with the telephone IDs of the first, the second and the third telephone terminals, respectively, based on the reference result.

5. The server apparatus according to claim 4, wherein
the controller updates the participation registration table to associate a telephone ID of a fourth telephone terminal not registered in the participation registration information table with the participation information, when a registration request is made from the fourth telephone terminal to the participation registration table in a state in which a communication connection related to the paging function is established among the first data terminal associated with the telephone ID of the first telephone terminal and the second and the third telephone terminals associated with each telephone ID of the second and the third telephone terminals.

6. The server apparatus according to claim 1, further comprising:
an interface which connects a broadcast processing unit to perform communication connection processing among the plurality of data terminals, wherein
the controller makes the broadcast processing unit perform the communication connections among the data terminals associated with the telephone IDs of the first, the second and the third telephone terminals, respectively, via the interface.

7. The server apparatus according to claim 6, wherein
the controller updates the participation registration table to associate the telephone ID of the fourth telephone terminal with the participation information and transmits session control instruction information necessary to perform a communication connection of a fourth terminal to be associated with the fourth telephone ID of the fourth telephone terminal to the broadcast processing unit via the interface, when a registration request is made from the fourth telephone terminal not registered in the participation registration table to the participation registration table in a state in which a communication connection related to the paging function is established among the first data terminal associated with the telephone ID of the first telephone terminal and the second and the third telephone terminals associated with each telephone ID of the second and the third telephone terminals.

8. The server apparatus according to claim 4, further comprising:
a connecting unit which makes the telephone exchange apparatus perform call connections among the first, the second and the third telephone terminals by a paging function, when an execution request of paging function is generated from the first terminal associated with the telephone ID of the first telephone terminal, the execution request specifying a second and a third terminals to be associated with the telephone IDs of the second and the third telephone terminals.
